(19) United States
(12) Patent Application Publication
(10) Pub. No.: US 2007/0013996 A1
(43) Pub. Date: Jan. 18, 2007

(54) QUANTUM DOT VERTICAL LASING SEMICONDUCTOR OPTICAL AMPLIFIER

(75) Inventor: Ashish K. Verma, San Jose, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: Finisar Corporation, Sunnyvale, CA (US)

(21) Appl. No.: 11/457,094

(22) Filed: Jul. 12, 2006

Related U.S. Application Data
(60) Provisional application No. 60/699,263, filed on Jul. 14, 2005.

(51) Int. Cl. H01S 3/00

(52) U.S. Cl. 359/344

(57) ABSTRACT

This disclosure concerns a vertical lasing semiconductor optical amplifier (VLSOA) having a quantum dot active region. In one example, a VLSOA includes a quantum dot active region comprising a semiconductor gain medium. The semiconductor gain medium defines at least a portion of an amplifying path. The VLSOA also includes a laser cavity within which a portion of the semiconductor gain medium is disposed. The laser cavity has a gain characteristic, with respect to an optical signal traversing the amplifying path, that is responsive to a pump input to the laser cavity.

### RELATED APPLICATION

This application claims the benefit of U.S. Provisional Patent Application Ser. No. 60/699,263, entitled QUANTUM DOT VERTICAL LASING SEMICONDUCTOR OPTICAL AMPLIFIER, filed Jul. 14, 2005, and incorporated herein in its entirety by this reference.

### BACKGROUND OF THE INVENTION

1. The Field of the Invention

This invention generally relates to high speed data transmission systems and more specifically, example embodiments concern a vertical lasing semiconductor optical amplifier having a quantum dot active region.

2. Related Technology

Computer and data communications networks continue to develop and expand due to declining costs, improved performance of computer and networking equipment, the remarkable growth of the internet and the resulting increased demand for communication bandwidth. Such increased demand occurs within and between metropolitan areas as well as within communications networks. Moreover, as organizations have recognized the economic benefits of using communications networks, network applications such as electronic mail, voice and data transfer, host access, and shared and distributed databases are increasingly used as a means to increase user productivity. This increased demand, together with the growing number of distributed computing resources, has resulted in a rapid expansion of the number of fiber optic systems required.

Through fiber optics, digital data in the form of light signals is formed by light emitting diodes or lasers and then propagated through a fiber optic cable. Such light signals allow for high data transmission rates and high bandwidth capabilities. In a typical fiber-optic network, however, the transmission and reception of data is not strictly limited to optical signals. Digital devices such as computers may communicate using both electronic and optical signals. As a result, optical signals need to be converted to electronic signals and electrical signals need to be converted to optical signals. To convert electronic signals to optical signals for transmission on an optical fiber, a transmitter is often used. A transmitter uses an electronic signal to drive a laser or light emitting diode to generate an optical signal. When optical signals are converted to electronic signals, a receiver is used. The receiver has a photodiode that, in conjunction with other circuitry, detects optical signals and converts the optical signals to electronic signals.

A typical optical communications system includes a transmitter, an optical fiber, and a receiver. In these systems, phenomena such as fiber losses, losses due to insertion of components in the transmission path, and splitting of the optical signal may attenuate the optical signal and degrade the corresponding signal-to-noise ratio as the optical signal propagates through the communications system. Optical amplifiers can be used to compensate for these attenuations. Also, since receivers typically operate properly only within a relatively narrow range of optical signal power levels, optical amplifiers can be used to boost an optical signal power to the proper range for a receiver.

More specifically, an optical amplifier can be used to apply a gain to an optical signal. This gain is measured by the power of the signal leaving the amplifier divided by the power of the signal entering the amplifier. Therefore, if the signal's gain through an amplifier is greater than one, then the amplifier has amplified the signal by increasing the signal's power. For an optical amplifier to function correctly in a system, it is desirable for the optical amplifier to have a known and stable gain. If the optical amplifier's gain is not known and stable, it is difficult to design and build optical systems incorporating the optical amplifier.

One type of amplification technology is semiconductor optical amplifiers (SOAs). SOAs have the advantage of small size and power consumption, as well as the scalable economics of semiconductor manufacturing technology. However, the SOA also suffers from cross-talk phenomena, which has limited its performance in Wavelength Division Multiplexing (WDM) systems, particularly in long haul applications. The primary origin of cross-talk in SOAs is gain saturation. In this phenomenon, gain is reduced as the optical power in the amplifier increases. This saturation effect can result in deleterious effects, such as inter-symbol interference (ISI) and WDM cross-talk, when excessive power is injected into the amplifier. The traditional metric for this maximum allowable output power is the 3-dB saturation power, Pₛₐₜ. For most practical applications, however, the usable linear regime for SOA-based amplifiers is limited to output powers for which gain compression is less than 0.5 dB, i.e., Pₗᵢₙₑₐᵣ=P(GC=0.5 dB).

Multiple approaches have been proposed for addressing the cross-talk issue in SOAs. Many of these approaches have focused on maximization of Pₛₐₜ, through optimization of waveguide and active region design. Traditionally, however, SOAs have suffered from somewhat soft (high curvature) gain saturation curves, resulting in Pₗᵢₙₑₐᵣ<5 dBm, even when Pₛₐₜ is reasonably large. As a result, undesirable gain transients can result in abnormal operation, particularly during channel adding and dropping.

Another approach for addressing the cross-talk issue in SOAs is that of gain clamping, which utilizes a laser ballast field to stabilize the amplifier gain. One previous device is a chip-based amplifier that has an optimal “cross-cavity” gain-clamped configuration, in which the laser ballast is provided by a vertical cavity surface emitting laser (VCSEL), integrated perpendicular to the amplification path. Rather than saturating the amplifier gain, injected photons instead remove VCSEL photons from the cavity. The resulting gain saturation curve is considerably flatter than that of an SOA, resulting in Pₗᵢₙₑₐᵣ of 10 dBm or more. This device is referred to herein as a “vertical lasing semiconductor optical amplifier (VLSOA), where the term “vertical lasing” refers to the laser ballast provided by the VCSEL like laser structures employed.

VLSOAs, like VCSELs, are typically made by growing several layers on a substrate material. VCSELs include a first mirrored stack, formed on the substrate by semiconductor manufacturing techniques, an active region, formed on top of the first mirrored stack, and a second mirrored stack formed on top of the active region. By providing a first contact on top of the second mirrored stack, and a second contact on the backside of the substrate, a current is forced through the active region, thus driving the VCSEL. The active region in both VLSOAs and VCSELs is further made up of a gain region, which consists of either a bulk semiconductor layer or multiple quantum well (MQW) layers. By selecting the appropriate materials for the quantum well and any adjacent layers, a VCSEL generally may be grown or fabricated that generates light at a desirable, predetermined wavelength. For example, by using InGaAs quantum wells on GaAs substrates, longer wavelength VCSELs can be produced.

Despite the various advantages of the foregoing devices, however, there is a continuing need for improved, lower cost, amplifiers that reduce crosstalk, provide good ISI immunity, maintain high gain transient immunity during channel adding and dropping, and can be operated at high output power.

### BRIEF SUMMARY OF SOME EXAMPLE EMBODIMENTS

In general, example embodiments of the invention are concerned with high speed data transmission systems and more specifically, to a vertical lasing semiconductor optical amplifier having a quantum dot active region.

Accordingly, an example embodiment of the invention is a vertical lasing semiconductor optical amplifier (VLSOA). The VLSOA includes a quantum dot active region comprising a semiconductor gain medium. The semiconductor gain medium defines at least a portion of an amplifying path. The VLSOA also includes a laser cavity within which a portion of the semiconductor gain medium is disposed. The laser cavity has a gain characteristic, with respect to an optical signal traversing the amplifying path, that is responsive to a pump input to the laser cavity.

Another example embodiment of the invention is also a VLSOA. This example VLSOA includes a laser cavity including a quantum dot semiconductor gain medium and a pump input to the semiconductor gain medium. In this example VLSOA, the semiconductor gain medium defines at least a portion of an amplifying waveguide path that traverses the quantum dot semiconductor gain medium from a first cleaved facet to a second cleaved facet of the quantum dot semiconductor gain medium. Also, the amplification path is tilted from about 5 degrees to about 15 degrees with respect to a crystal plane having a Miller index of about [100]. The pump input functions to pump the quantum dot semiconductor gain medium above a lasing threshold for the laser cavity.

Yet another example embodiment of the invention is another VLSOA. This example VLSOA includes a semiconductor gain medium in a laser cavity, a pump input for pumping the semiconductor gain medium above a lasing threshold for the laser cavity, and an amplifying waveguide path. In this example embodiment, the semiconductor gain medium includes a lower distributed Bragg reflector mirror stack, an upper distributed Bragg reflector mirror stack, and a quantum dot active region disposed between the upper distributed Bragg reflector mirror stack and the lower distributed Bragg reflector mirror stack. Also in this example VLSOA, the semiconductor gain medium generates a ballast laser signal in response to the pump input. In addition, the amplifying waveguide path traverses the quantum dot active region. Also an optical signal entering the amplifying waveguide path experiences a gain, as it traverses the quantum dot active region, by acquiring photons from the electrical pumping of the active region.

These and other aspects of example embodiments of the present invention will become more fully apparent from the following description and appended claims.

### BRIEF DESCRIPTION OF THE DRAWINGS

To further clarify the above and other aspects of the present invention, a more particular description of these examples will be rendered by reference to specific embodiments thereof which are illustrated in the appended drawings. It is appreciated that these drawings depict only example embodiments of the invention and are therefore not to be considered limiting of its scope. It is also appreciated that the drawings are diagrammatic and schematic representations of example embodiments of the invention, and are not limiting of the present invention nor are they necessarily drawn to scale. The invention will be described and explained with additional specificity and detail through the use of the accompanying drawings in which:

FIG. 1 discloses an example of a vertical lasing semiconductor optical amplifier (VLSOA);

FIG. 2A is a perspective view of an example embodiment of a VLSOA;

FIG. 2B is a detailed transverse cross-sectional view of an example embodiment of a VLSOA; and

FIG. 3 is a cross sectional schematic of another example embodiment of a VLSOA.

### DETAILED DESCRIPTION OF SOME EXAMPLE EMBODIMENTS

Example embodiments of the invention are concerned with vertical lasing semiconductor optical amplifiers (VLSOAS) having a quantum dot active region. Among other things, the example VLSOA disclosed herein exhibits good inter-symbol interference (ISI) immunity even when operated in saturation. The example VLSOA disclosed herein also exhibits improved suppression of cross-talk. Because quantum dot active regions exhibit ultrafast carrier/gain dynamics, quantum dot devices exhibit good ISI immunity even when operated in saturation. Example embodiments of the invention combine a VCSEL-like VLSOA cross-cavity with a quantum dot active region. This combination results in improved suppression of cross-talk. Specific types of cross-talk addressed by example embodiments of the invention include inter-symbol interference (ISI), cross-gain modulation (XGM), and gain transients that occur during channel add/drop. The combination of gain clamping technology and quantum dot active regions in example embodiments of the invention results in an amplifier with improved characteristics and improved suppression of cross-talk.

In operation, the VCSEL laser cavity generates a laser signal, which acts as a ballast. As injected light grows exponentially along the VLSOA, amplifier photons do not reduce the gain by depleting carriers, as in a conventional SOA, but rather by removing VCSEL photons from the laser cavity. Under high injection and/or high gain conditions for prior VLSOA devices, the population of amplifier photons may grow so large as to completely remove all VCSEL photons from the laser cavity, resulting in ISI problems. The quantum dots of embodiments of the invention exhibit ultrafast carrier/gain dynamics, allowing the photons to regenerate quickly enough to provide sufficient ISI immunity.

Such semiconductor based amplifiers have a competitive advantage with regard to cost, size, and power consumption compared to fiber amplifiers. At least some embodiments of the VLSOA amplifiers can exhibit the above characteristics over a large bandwidth, of up to 120 nm, making those amplifiers attractive for CWDM applications.

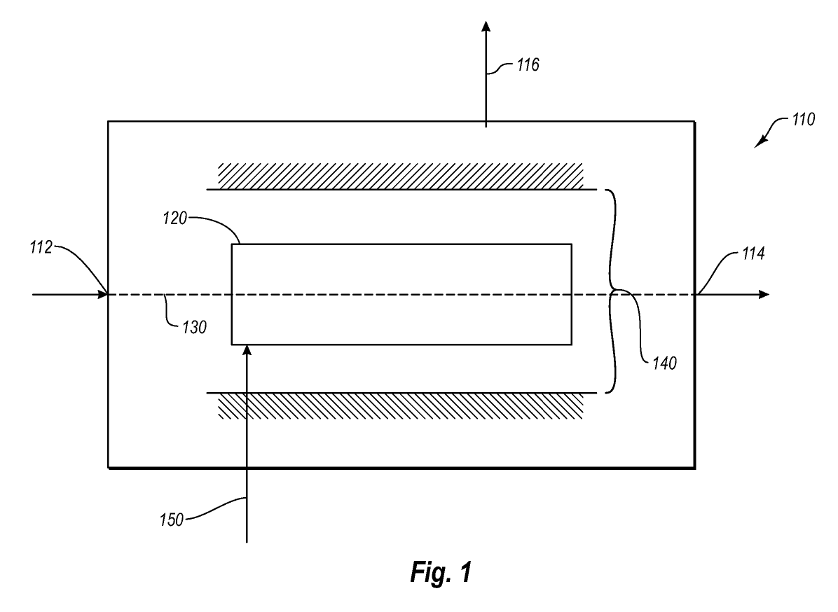

Referring now to FIG. 1, details are provided concerning a diagram of an example vertical lasing semiconductor optical amplifier (VLSOA) 110. The VLSOA 110 has an amplifier input 112 and an amplifier output 114. The VLSOA 110 further includes a semiconductor gain medium 120, with an amplifying path 130 coupled between the amplifier input 112 and the amplifier output 114 of the VLSOA 110 and traveling through the semiconductor gain medium 120. The VLSOA 110 further includes a laser cavity 140, which includes the semiconductor gain medium 120, and a pump input 150 coupled to the semiconductor gain medium 120. The laser cavity 140 is oriented substantially vertically with respect to the amplifying path 130. The pump input 150 is for receiving a pump source that produces a pump beam to pump the semiconductor gain medium 120 above a lasing threshold for the laser cavity 140. When pumped above the lasing threshold, the laser cavity 140 generates a laser signal, which shall be referred to herein as the ballast laser signal. The VLSOA 110 further includes a ballast laser output 116 through which the ballast laser signal exits the VLSOA 110.

The semiconductor gain medium 120 includes a quantum dot based active region, also known as a quantum dot active region. Therefore, the semiconductor gain medium 120 is properly termed a quantum dot semiconductor gain medium. Quantum dots are nanometer-scale semiconductor crystals with a core composed of semiconductor material, such as indium gallium arsenide (InGaAs). Other possible core materials include, but are not limited to, cadmium selenide (CdSe), cadmium sulfide (CdS), and cadmium telluride (CdTe). The core may be coated by a shell material, examples of which include indium gallium arsenide phosphide (InGaAsP) and zinc sulfide (ZnS). The choice of material of the quantum dots core can be used to dictate the spectrum of emission. Further, the size of the crystals can be selected to tune the emission wavelength within the spectrums available for each substance. However, the scope of the invention is not limited to any particular core or shell materials.

Note that the gain experienced by the optical signal as it propagates through the VLSOA 110 is determined by various parameters. For example, gain is determined in part by the gain value of the semiconductor gain medium 120 and by the length of the amplifying path 130. The gain value of the semiconductor gain medium 120 is, in turn, is determined primarily by the lasing threshold for the laser cavity 140. Above threshold, the gain is clamped to the value of the round-trip loss in the laser cavity 140. In particular, the gain experienced by the optical signal as it propagates through the VLSOA 110 is substantially independent of the amplitude of the optical signal.

Non-lasing SOAs, on the other hand, exhibit significant gain saturation as the signal power in the amplifying waveguide is increased. This gain saturation, coupled with insufficiently fast carrier dynamics in the SOA active region, is the primary cause of SOA signal distortion in high speed applications.

In the VLSOA 110, excess photons in the laser cavity 140 can be carried away in the laser field, and hence do not participate in gain saturation. Typically, over the range of output powers for which one example of an SOA experiences 3 dB of gain saturation, the VLSOA 110 experiences a gain compression of <0.5 dB. In addition, carrier dynamics are faster in the presence of a lasing field. This combination of effects results in vastly reduced signal crosstalk and gain transient effects, compared to non-lasing SOAs.

SOAs with quantum dot active regions, such as VLSOA 110, exhibit significantly enhanced gain and 3 dB saturation output power, compared to bulk and multiple quantum well (MQW) active regions. In addition, quantum dot based SOAs exhibit ultrafast carrier/gain dynamics, which allow substantially distortion-free amplification even when the SOA is operated in the gain saturation region. The term “ultrafast” describes events that occur on femtosecond timescales. Because quantum dot based active regions exhibit ultrafast carrier/gain dynamics, the VLSOA 110 exhibits very good ISI immunity even when operated in saturation. In the VLSOA 110, the combination of the quantum dot active region with the cross cavity laser thus provides improved gain and ISI immunity over an extended range of output powers, with excellent gain transient immunity.

In operation, the VLSOA 110 receives an optical signal at its amplifier input 112. The optical signal propagates along the amplifying path 130. The pump source received at pump input 150 produces a pump beam that pumps the semiconductor gain medium 120 above a lasing threshold of the laser cavity 140. When lasing occurs, the round-trip gain experienced by the optical signal offsets the round-trip losses experienced by the optical signal in the laser cavity 140. In other words, the gain imposed by the semiconductor gain medium 120 is clamped, or limited, to the gain value necessary to offset the round-trip losses. The optical signal is amplified according to this gain value as it propagates along the amplifying path 130 through the semiconductor gain medium 120. The amplified signal exits the VLSOA 110 via the amplifier output 114. The ballast laser signal from the laser cavity 140 exits the VLSOA 110 via the ballast laser output 116. Note that there are two optical outputs for the VLSOA 110: the amplifier output 114 and the ballast laser output 116. When operated as an amplifier, the VLSOA 110 can be used as a gain element in optical circuits.

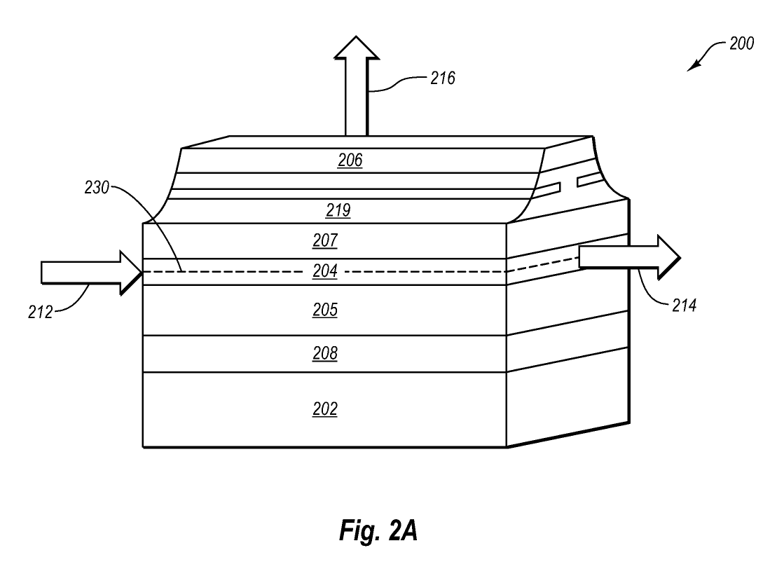

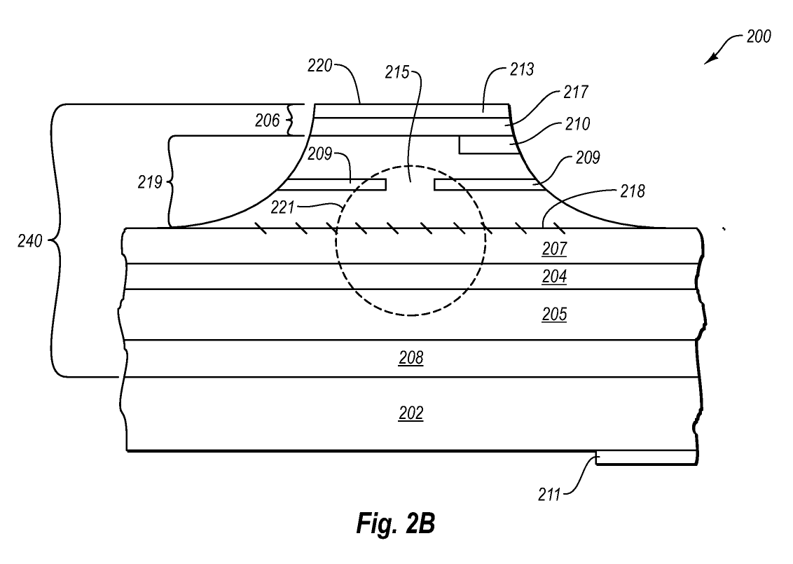

FIGS. 2A-2B disclose a perspective view and a transverse cross-sectional view, respectively, of an embodiment of a VLSOA 200. With reference now to FIGS. 2A and 2B, VLSOA 200 includes a substrate 202, a bottom mirror 208, a bottom cladding layer 205, an active region 204, a top cladding layer 207, a confinement layer 219, and a top mirror 206. The bottom-cladding layer 205, active region 204, top cladding layer 207, and confinement layer 219 are in electrical contact with each other and may also be in direct physical contact as well.

As disclosed in greater detail in FIG. 2B, an optional delta doping layer 218 can be located between the top cladding layer 207 and confinement layer 219. The confinement layer 219 also includes a confinement structure 209, which helps define optical aperture 215. The VLSOA 200 also includes an electrical contact 210 located above the confinement structure 209, and a second electrical contact 211 formed on the bottom side of substrate 202. All layers above substrate 202 are included as part of a laser cavity 240.

Comparing the VLSOA 200 of FIGS. 2A and 2B to the VLSOA 110 of FIG. 1, the semiconductor gain medium 120 of the VLSOA 110 includes the quantum dot based active region 204 of the VLSOA 200. Also, the laser cavity 140 of the VLSOA 110 is formed primarily by the two mirrors 206 and 208 and the active region 204 of the VLSOA 200. The VLSOA 110 and the VLSOA 200 are electrically pumped and the pump input 150 of the VLSOA 110 is applied by way of the electrical contacts 210 and 211 of the VLSOA 200. A ballast laser signal exits the VLSOA 200 through the ballast laser output 216. The ballast laser output 216 is formed in a portion of the top surface 220 of the VLSOA 200.

With reference again to FIGS. 2A and 2B, the VLSOA 200 is a vertical lasing semiconductor optical amplifier since the laser cavity 240 is a vertical laser cavity. That is, the laser cavity 240 is oriented substantially vertically with respect to the amplifying path 230 and the substrate 202. As the length of the VLSOA 200 in the longitudinal direction is increased, the length of the amplifying path 230 is increased, resulting in increased amplification of the optical signal. The entire VLSOA 200 is an integral structure formed on a single substrate 202 and may be integrated or otherwise combined with other optical elements. In some cases, optical elements which are optically coupled directly to VLSOA 200 will be optically coupled to the amplifying path 230 within the VLSOA. Depending on the manner in which the VLSOA 200 is combined with other optical elements, the optical input 212 and output 214 and the ballast laser output 116 may not exist as a distinct structure or facet but may simply be the boundary between the VLSOA 200 and other optical elements. Furthermore, although this disclosure discusses a single implementation of the VLSOA 200, the teachings herein apply equally to arrays of VLSOAs.

As disclosed in FIGS. 2A and 2B, the VLSOA 200 is a layered structure, allowing the VLSOA 200 to be fabricated using semiconductor fabrication techniques, including, but not limited to, metal organic chemical vapor deposition (MOCVD). Other common fabrication techniques include, but are not limited to, molecular beam epitaxy (MBE), liquid phase epitaxy (LPE), photolithography, e-beam evaporation, sputter deposition, wet and dry etching, wafer bonding, ion implantation, wet oxidation, and rapid thermal annealing.

The optical signal amplified by the VLSOA 200 is confined in the vertical direction by index differences between bottom cladding layer 205, the active region 204, and the top cladding layer 207, and to a lesser extent by index differences between the substrate 202, the bottom mirror 208, the confinement layer 219, and the top mirror 206. Specifically, active region 204 has a higher index than the bottom cladding layer 205 and top cladding layer 207 and therefore acts as a waveguide core with respect to the cladding layers 205 and 207. The optical signal is confined in the transverse direction by index differences between the confinement structure 209 and the resulting optical aperture 215. The confinement structure 209 may also extend vertically from the bottom mirror 208 to the top mirror 206, thereby providing lateral confinement as well. Particularly, the optical aperture 215 would extend from bottom mirror 208 to the top mirror 206, thus providing the lateral confinement. In this example, the optical aperture 215 has a higher index of refraction than the confinement structure 209. As a result, the mode of the optical signal to be amplified is generally concentrated in dashed region 221. The amplifying path 230 disclosed in FIG. 2A is through the active region 204, in the direction in/out of the plane of the view disclosed in FIG. 2B.

The choice of materials system will depend in part on the wavelength of the optical signal to be amplified, which in turn will depend on the application. Wavelengths in the approximately 1.3-1.6 micron region are useful in telecommunications applications, due to the spectral properties of optical fibers. The approximately 1.28-1.35 micron region is useful for data communications over single mode fiber, with the approximately 0.8-1.1 micron region being one example of an alternate wavelength region. In one embodiment, the VLSOA 200 is configured for use with the 1.55 micron wavelength.

With continuing reference to FIGS. 2A and 2B, examples of the top and bottom mirrors 206 and 208 include distributed Bragg reflectors (DBRs), and non-DBRs such as metallic mirrors. In the example of FIG. 2B, the bottom mirror 208 is a DBR. The top mirror 206 is a hybrid mirror that includes a DBR 217 and a metallic mirror 213. DBRs may be fabricated using various materials systems, including for example, alternating layers of GaAs and AlAs, SiO₂ and TiO₂, InAlGaAs and InAlAs, InGaAsP and InP, AlGaAsSb and AlAsSb, or GaAs and AlGaAs. Gold is one material suitable for metallic mirrors.

Moving now to the composition of other components of the VLSOA 200, the electrical contacts 210 and 211 are metals that form an ohmic contact with the semiconductor material. Suitable metals include titanium, platinum, nickel, germanium, gold, palladium, and aluminum. In the VLSOA 200, the laser cavity 240 is electrically pumped by injecting a pump current into the active region 204 via the electrical contacts 210 and 211. In this particular embodiment, the electrical contact 210 is a p-type contact to inject holes into the active region 204, and the contact 211 is an n-type contact to inject electrons into the active region 204. Where the top mirror 206 is conductive, the electrical contact 210 may be located either below or above the top mirror 206. The top mirror 206 is conductive, for example, where the top mirror 206 comprises doped semiconductor material.

The electrical contact 210 is located above the semiconductor structure which, in this example, includes the confinement layer 219 and any semiconductor portion of the DBR 217. The electrical contact 210 is located below any dielectric portion of the DBR 217. For simplicity, in FIG. 2B, the electrical contact 210 is disclosed as being located between the confinement layer 219 and the DBR 217, which would be the case if the DBR 217 were entirely dielectric. In some embodiments, the VLSOA 200 may have a number of isolated electrical contacts, in addition to the electrical contact 210, to allow for independent pumping within the VLSOA 200. Since the length of the VLSOA 200 in the longitudinal direction is greater than a typical SOA, independent pumping allows different voltages and ballast levels to be maintained at different points along the VLSOA 200. Alternately, different contacts may be doped to have a finite resistance and thereby be electrically isolated.

In one embodiment, the confinement structure 209 is formed by wet oxidizing the confinement layer 219. Alternately, the confinement layer 219 may be fabricated using etch and regrowth techniques. The confinement structure 209 has a lower index of refraction than the optical aperture 215. Hence, the effective cross-sectional size of the laser cavity 240 is determined in part by the optical aperture 215. In other words, the confinement structure 209 provides lateral confinement of the optical mode of the laser cavity 240. In one example embodiment, the confinement structure 209 also has a lower conductivity than the optical aperture 215. Thus, pump current injected through the electrical contact 210 will be channeled through the optical aperture 215, increasing the spatial overlap with the optical input signal 212. In this way, the confinement structure 209 provides electrical confinement of the pump current.

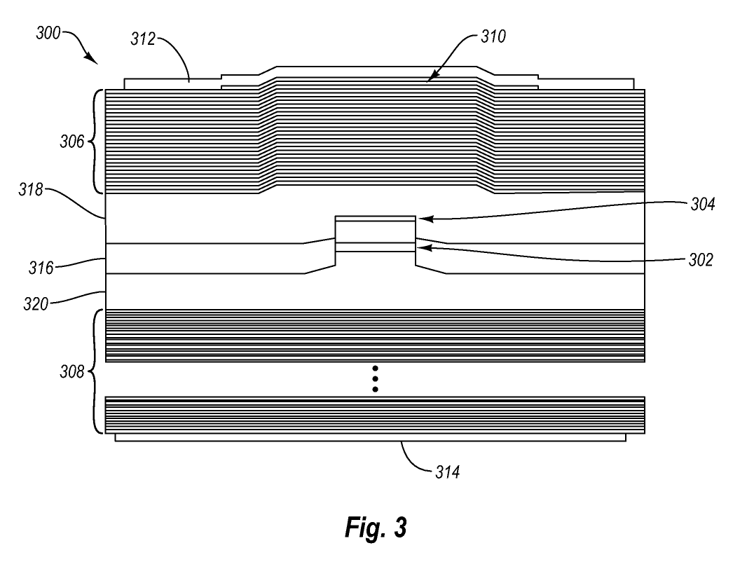

With attention now to FIG. 3, details are provided concerning another example VLSOA structure 300. The VLSOA structure 300 generally comprises a VCSEL integrated perpendicularly to the amplifying path. The laser cavity of the VCSEL is oriented substantially perpendicularly to the amplifying waveguide path of the VLSOA structure 300. In one example, the VLSOA structure 300 is grown using metal organic chemical vapor deposition (MOCVD), employing multiple regrowth steps.

A quantum dot based active region 302 functions as the active region for the vertical lasing structure and as the amplifying waveguide path for the amplifier. The orientation, configuration and geometry of the active region 302 can be varied as desired. In one example, the width of the active region 302 can be, by way of example, approximately 2 μm. In one example, a buried heterostructure (BH) geometry for active region 302 is employed to minimize waveguide loss and to improve current confinement. The VLSOA structure 300 includes a BH geometry comprising a BH blocking structure. The BH blocking structure includes a reverse-biased InP p/n junction. The reverse-biased InP p/n junction includes p-InP layer 316 and n-InP layers 318 and 320. In another example, the BH geometry for active region 302 could comprise a semi-insulating material, which would also achieve an electrical blocking effect similar to that obtained with the reverse-biased p/n junction.

A tunnel junction 304 is placed above the active region. In one embodiment, the tunnel junction 304 can comprise strained InGaAs:C/InGaAs:Te, but the scope of the invention is not so limited. Among other things, utilization of the tunnel junction 304 minimizes the use of p-doped material in the amplification waveguide path. The resulting reduction in free carrier absorption reduces the VCSEL round-trip loss, and also further reduces the amplifier waveguide loss. The tunnel junction 304 also serves to increase current confinement, resulting in higher differential gain of the optical signal as it passes thru the VLSOA structure 300.

A vertical cavity is formed in the VLSOA structure 300 by placing InP/InGaAsP DBR mirror stacks 306 and 308 above and below the active region 302. Due to the utilization of the tunnel junction 304, both mirror stacks 306 and 308 can be made with n-type material, thereby reducing the VCSEL round-trip loss. The bottom DBR 308 can include 60 mirror pairs, depending on the index contrast of the constituent layers of those pairs. The top DBR 306 is a hybrid mirror, including about 18 mirror pairs plus a gold reflector 310. Top and bottom electrical contacts 312 and 314 facilitate supply of current to the VLSOA 300. In one embodiment, the electrical contacts 312 and 314 are formed by e-beam deposition of Au/Pt/Ti, but other processes and materials can be used.

In order to substantially prevent lasing in the direction of the amplification path across the active region 302 in FIG. 3, the amplification path in VLSOA 300 is tilted by about 10 degrees with respect to a crystal plane of the active region having a Miller index of [100]. A Miller index of [100] specifies a 180 degree orientation for n-type materials and 90 degree orientation for p-type materials. In addition, anti-reflection coatings can be deposited on cleaved facets (not depicted) at both the input and output ends of the amplifying waveguide path in the example VLSOA 300. One such example cleaved facet is the face of the VLSOA 200 out of which output 214 travels, as disclosed on the right side of FIG. 2A. In one example embodiment, the length of the VLSOA 300 from left to right in FIG. 3 is about 1 mm.

In various embodiments of optical logic devices, various components may be optically coupled by waveguides, optically coupled directly to each other, optically coupled by fibers, or optically coupled using free space systems such as lenses and/or mirrors. Further, the example VLSOAs 110, 200 and 300 disclosed herein may be combined with other optical elements to form the optical logic devices. Other optical elements can include, for example, optical waveguides, optical transmitters, optical receivers, lenses, and reflectors. The combination of the example VLSOAs 110, 200 and 300 disclosed herein with other optical elements may be implemented using any number of techniques. In one approach, both the VLSOA and the other elements are formed on a common substrate using a common fabrication process, but with at least one fabrication parameter, such as the thickness of one or more layers, varying as between the VLSOA and the optical element. For example, selective area epitaxy (SAE) and impurity induced disordering (IID) are two fabrication processes which may be used in the aforementioned manner.

In one approach based on SAE, a nitride or oxide SAE mask is placed over selected areas of the substrate. Material is deposited on the masked substrate. The SAE mask results in a difference between a transition energy, such as the bandgap energy, of the material deposited on a first unmasked area of the substrate and the transition energy of the material deposited on a second unmasked area of the substrate. For example, the material deposited on the first unmasked area might form part of the active region of the VLSOA and the material deposited on the second unmasked area might form part of the core of a waveguide or other optical element, with the difference in transition energy accounting for the different optical properties of the active region and the waveguide core. SAE results in a smooth interface between optical elements and therefore reduces optical scattering at this interface. This, in turn, reduces both parasitic lasing modes and gain ripple. Furthermore, the SAE approach can be confined to only the minimum number of layers necessary, for example to only the active region, thus minimizing the impact of the SAE fabrication process on the rest of the integrated optical device.

In another approach based on IID, an IID mask is placed over selected areas of the substrate. The masked substrate is bombarded with impurities, such as silicon or zinc, and subsequently annealed to cause disordering and intermixing of the materials in the bombarded region. In this way, the IID mask facilitates achievement of a difference between the transition energy of the material underlying a masked area of the substrate, and the transition energy of the material underlying an unmasked area of the substrate. Continuing the previous example, the masked area might form part of the VLSOA active region and the unmasked area might form part of the core of a waveguide, with the difference in transition energy again accounting for the different optical properties.

In the previous SAE and IID examples, the difference in transition energy results in different optical properties between the VLSOA active region and a waveguide. Manipulation of the respective transition energies may also be used to fabricate many other types of integrated optical devices. For example, changing the transition energy between two VLSOAs can be used to optimize each VLSOA for a different wavelength region. In this way, the transition energy in a VLSOA could be graded in a controlled way to broaden, flatten, and shape or otherwise configure the gain profile. Alternately, two different elements, such as a VLSOA and a laser might require different transition energies for optimal performance.

In a different approach, the VLSOA and the optical element are formed on a common substrate but using different fabrication processes. In one example, a VLSOA is formed on the common substrate in part by depositing a first set of materials on the substrate. Next, the deposited material is removed from selected areas of the substrate, for example by an etching process. A second set of materials is deposited in the selected areas to form in part the optical-element. Etch and fill is one process which follows this approach. Continuing the VLSOA and waveguide example from above, materials are deposited to form the VLSOA or at least a portion of the VLSOA. In the areas where the waveguide is to be located, these materials are removed and additional materials are deposited to form the waveguide or at least a portion of the waveguide.

In yet another approach, the VLSOA and the optical element are formed on separate substrates by separate fabrication processes and then integrated onto a common substrate. Planar lightwave circuitry and silicon optical bench are two examples of processes that can be employed in this fashion. In one example, the VLSOA is formed on a first substrate. The optical element is formed on a second substrate. The VLSOA and the optical element are then integrated onto a common substrate, which could be the first substrate, the second substrate or a completely different substrate.

In general then and as exemplified by the aforementioned embodiments, various manufacturing processes and techniques can be used to produce optical devices whose components include, among other things, VLSOAs such as are disclosed herein. Accordingly, the scope of the invention is not limited to the exemplary processes, techniques, devices and components discloser herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A vertical lasing semiconductor optical amplifier (VLSOA) comprising:
a semiconductor gain medium comprising a quantum dot active region, the semiconductor gain medium defining at least a portion of an amplifying path; and
a laser cavity within which a portion of the semiconductor gain medium is disposed, the laser cavity having a gain characteristic, with respect to an optical signal traversing the amplifying path, that is responsive to a pump input to the laser cavity.

2. The VLSOA as recited in claim 1, wherein the quantum dot active region comprises an Indium Gallium Arsenide (InGaAs) core and an Indium Gallium Arsenide Phosphide (InGaAsP) shell.

3. The VLSOA as recited in claim 1, wherein the semiconductor gain medium further comprises:
a substrate;
a first mirror stack above the substrate and below the quantum dot active region; and
a second mirror stack above the quantum dot active region.

4. The VLSOA as recited in claim 1, further comprising:
an input to the amplifying waveguide path, the input adapted to receive an optical signal; and
an output coupled to the amplifying waveguide path, the output adapted to transmit an optical signal from the VLSOA.

5. The VLSOA as recited in claim 1, further comprising a tunnel junction upon the quantum dot active region.

6. The VLSOA as recited in claim 5, wherein the tunnel junction comprises strained InGaAs:C/InGaAs:Te.

7. The VLSOA as recited in claim 1, wherein the laser cavity is oriented substantially perpendicularly to the amplifying waveguide path.

8. The VLSOA as recited in claim 1, wherein the laser cavity includes a pump input and a ballast laser signal output and an amplified optical signal output having a clamped gain.

9. A vertical lasing semiconductor optical amplifier (VLSOA) comprising:
a laser cavity including a quantum dot semiconductor gain medium, the quantum dot semiconductor gain medium defining at least a portion of an amplifying waveguide path, the amplifying waveguide path traversing from a first cleaved facet to a second cleaved facet of the quantum dot semiconductor gain medium, wherein the amplification waveguide path is tilted from about 5 degrees to about 15 degrees with respect to a crystal plane of the quantum dot semiconductor gain medium having a Miller index of about [100]; and
a pump input to the quantum dot semiconductor gain medium for pumping the quantum dot semiconductor gain medium above a lasing threshold for the laser cavity.

10. The VLSOA as recited in claim 9, wherein the laser cavity is oriented substantially vertically with respect to the amplifying path.

11. The VLSOA as recited in claim 9, wherein: the VLSOA comprises layers of different materials stacked on a substrate; and the laser cavity comprises a top mirror and a bottom mirror opposing the top mirror, each mirror including at least one of the stacked layers.

12. The VLSOA as recited in claim 11, further comprising:
a confinement layer located below the top mirror and above the bottom mirror; and
an electrical contact located above the confinement layer and also located above any semiconduction portion of the top mirror; the electrical contact also located below any dielectric portion of the top mirror.

13. The VLSOA as recited in claim 9, wherein the quantum dot semiconductor gain medium comprises an Indium Gallium Arsenide (InGaAs) core and an Indium Gallium Arsenide Phosphide (InGaAsP) shell.

14. The VLSOA as recited in claim 9, further comprising a tunnel junction upon an active region in the quantum dot semiconductor gain medium.

15. The VLSOA as recited in claim 14, wherein the tunnel junction comprises strained InGaAs:C/InGaAs:Te.

16. The VLSOA as recited in claim 9, wherein the laser cavity generates a ballast laser signal and clamps a gain seen by an optical signal traversing the amplifying waveguide path.

17. The VLSOA as recited in claim 9, further comprising anti-reflection coatings deposited on the first cleaved facet and the second cleaved facet

18. An optical logic device comprising at least one optical element optical coupled to the VLSOA as recited in claim 9, wherein the at least one optical element and the VLSOA are formed on a common substrate.

19. An optical system comprising:
a housing;
an optical transmitter at least partially disposed within the housing;
a VLSOA as recited in claim 9 optically coupled to the optical transmitter; and
an optical receiver at least partially disposed within the housing.

20. The VLSOA as recited in claim 9, wherein the quantum dot active regions is substantially immune to inter-symbol interference even when operated in saturation.

21. A vertical lasing semiconductor optical amplifier (VLSOA) comprising:
a semiconductor gain medium in a laser cavity, comprising:
a lower distributed Bragg reflector mirror stack;
an upper distributed Bragg reflector mirror stack; and
a quantum dot active region disposed between the upper distributed Bragg reflector mirror stack and the lower distributed Bragg reflector mirror stack;
a pump input for pumping the semiconductor gain medium above a lasing threshold for the laser cavity, whereby the semiconductor gain medium includes a ballast laser signal output; and
an amplifying waveguide path traversing the quantum dot active region, wherein an optical signal entering the amplifying waveguide path experiences a gain, as it traverses the quantum dot active region, by acquiring photons from the electrical pumping of the quantum dot active region.

22. The VLSOA as recited in claim 21, wherein the amplification path terminates at first and second cleaved facets of the VLSOA, wherein the VLSOA further comprises antireflection coatings on each of the first and second cleaved facets.

23. The VLSOA as recited in claim 21, further comprising a tunnel junction above the quantum dot active region.

24. The VLSOA as recited in claim 23, wherein the tunnel junction comprises strained InGaAs:C/InGaAs:Te.
